(19) United States
(12) Patent Application Publication
(10) Pub. No.: US 2008/0277850 A1
(43) Pub. Date: Nov. 13, 2008

(54) Skateboard Repair Fixture

(76) Inventors: Kenneth Taylor, Dayton, IN (US); Tyrone Taylor, Dayton, IN (US)

Correspondence Address: DUNLAP CODDING, P.C., PO BOX 16370, OKLAHOMA CITY, OK, 73113, US

(21) Appl. No.: 12/048,826

(22) Filed: Mar. 14, 2008

Related U.S. Application Data
(60) Provisional application No. 60/918,027, filed on Mar. 14, 2007.

(51) Int. Cl. B23Q 1/25

(52) U.S. Cl. 269/53

(57) ABSTRACT

A skateboard repair fixture comprising a frame that includes an engagement member, such as a threaded rod that is generally aligned with the kingpin of the truck and extendable to contact a defective kingpin for removal from the baseplate or the insertion of a replacement kingpin thereinto. The frame is configured to include one or more of predetermined support positions therealong such that the first baseplate may assume a first orientation within a first support position for removal of the defective kingpin and a second orientation within the first or a second support position for seating its replacement. The frame may be configured to include additional support positions to accommodate different styles of skateboard truck baseplates or an adjustable member may be coupled to the frame to permit the orientation of particular truck baseplate to be adjusted in order to align the engagement member and kingpin. In another aspect of the invention, the frame is further configured such that a skateboard wheel may be aligned therealong to facilitate the removal of a defective wheel bearing by the engagement of the elongate engagement member in a first direction or to seat a replacement wheel bearing by movement of the elongate engagement member in a second direction.

### CROSS-REFERENCE TO RELATED APPLICATIONS

This application claims priority to a provisional application, Ser. No. 60/918,027 filed on Mar. 14, 2007.

### TECHNICAL FIELD

This invention relates to tools, more particularly to hardware used in the repair of skateboards.

### BACKGROUND OF THE INVENTION

A skateboard truck is the hardware that is attached underneath the deck or body of the skateboard. It is made up of the baseplate, typically made of aluminum, which is usually attached to the wood deck with screws or bolts, and the hanger, which serves as the attachment for a pair of plastic wheels, and is secured to the baseplate with a long bolt called the ‘kingpin’. There are two trucks per skateboard for the two sets of wheels. Bushings are included on either side of the hanger to cushion the truck when it turns, the softer the bushing, the easier it is to turn the skateboard.

Because the truck can be subject to great amounts of stress, particularly when using softer bushings, it is not uncommon for the kingpin to fracture, bend, or shear off upon occasion. When failure occurs, the broken kingpin can be quite difficult for the user to remove from the baseplate for replacement. Therefore, it is most common for the entire truck to be replaced, even though replacement kingpins are significantly cheaper than replacement trucks. If a user-friendly means of removing kingpins from the otherwise-operable truck was available to the owner, the potential exists for significant cost savings with replacement parts over the life of the skateboard.

What is needed is an apparatus that allows a skateboard owner to easily remove a broken kingpin from a particular truck style or brand and install a replacement kingpin so that an otherwise functional truck need not be replaced.

### SUMMARY OF THE INVENTION

The foregoing problems are solved and a technical advance is achieved in an illustrative fixture for repairing a skateboard, the fixture being configured to receive and align a skateboard truck baseplate with an engagement member such that a broken or defective kingpin can be extracted and a replacement kingpin inserted in its place.

In a first aspect of the present invention the fixture comprises a frame configured to include a plurality of support positions for receiving and positioning a skateboard truck baseplate into a first orientation in which the kingpin is may be dislodged therefrom by a movable engagement member, and a second orientation in which the engagement member facilitates the installation of a replacement kingpin. When the truck baseplate is situated in a predetermined first support position, the extendable engagement member, such as a rotatable threaded rod attached to a handle that is movably coupled to the frame, is aligned with the longitudinal axis of the kingpin such that advancement of the engagement member results in contact with the kingpin of the truck baseplate, or a remaining portion thereof. Further advancement of the engagement member pushes on and dislodges the kingpin so that a replacement kingpin can be inserted into and seated within the truck baseplate. To install the replacement kingpin, the skateboard truck baseplate is placed in a second support position disposed along the frame such that it assumes a second orientation whereby the replacement kingpin is generally aligned with the engagement member such that the new kingpin can be urged into place.

In another aspect of the present invention, the fixture for repairing a skateboard comprises a frame configured to include additional support positions to accommodate different styles and configurations of skateboard truck baseplates for situations where the first or second support positions along the frame are not configured to permit alignment of the engagement member and kingpin to facilitate removal of the latter. Preferably, the different predetermined locations or positions correspond to a particular type of truck baseplate and may be identified by indicia located on the frame or a separate diagram indicating which position is for receiving which type of baseplate.

In still another aspect of the present invention, the frame of the fixture for repairing a skateboard is further configured for facilitating the removal of the wheel bearing from a skateboard wheel and the insertion of a replacement bearing. In a first position, the engagement member is adapted to engage the bearing as the wheel is secured against the frame such that when the elongate engagement member is rotated in a first direction, the bearing is pulled and disengaged from the remainder of the wheel. The wheel is positionable into a second location along the frame and aligned to so that the advancing elongate engagement member contacts the center portion of the wheel to seat a replacement bearing thereinto.

In yet another aspect of the present invention, the repair fixture is conveniently sized and configured to fit within a user's hand during use of the fixture. The frame includes a first support position configured to receive a skateboard truck baseplate in a first orientation in which the longitudinal axes of the engagement member and kingpin (typically a portion thereof) are in general alignment such that advancement of the engagement member in a first direction relative to the truck baseplate causes the dislodgement of the kingpin therefrom. The first support position is also configured such that it receives the truck baseplate in a second orientation for installing the replacement kingpin. Typically, the truck baseplate is inverted into the second support position such that the engagement member is aligned with the longitudinal axis of the kingpin and is extendable to contact the head thereof to urge and seat the kingpin into place. An optional adjustment member, which may comprise a skateboard truck kingpin, may be coupled to the frame and configured to be extendable and retractable such that it may contact and adjust the position or orientation of a second (or third, etc.) style of the truck baseplate within the first support position. In situations where the different style of baseplate is in the first or second orientation within the support position and the engagement member and kingpin is misaligned, the adjustable member may be used to contact and reorient the truck baseplate by a sufficient amount until the kingpin is brought into alignment with the engagement member.

### BRIEF DESCRIPTION OF THE DRAWING

Embodiments of the present invention will now be described by way of example with reference to the accompanying drawings.

FIG. 1 depicts a perspective view of the illustrative embodiment of the present invention with a truck baseplate in a first position.

FIG. 2 depicts an enlarged side view of the distal portion of the engagement member of FIG. 1.

FIG. 3 depicts a side view of the embodiment of FIG. 1 in which the truck baseplate is located in the second orientation.

FIG. 4 depicts a cross-sectional view of an embodiment of the present invention adapted for the removal of a skateboard wheel bearing.

FIG. 5 depicts a side view of the embodiment of FIG. 4 in which a replacement wheel bearing is being installed.

FIG. 6 depicts a front view of an embodiment of the present invention configured for hand-held operation.

FIG. 7 depicts a side view of the embodiment of FIG. 6, wherein the truck baseplate is disposed in a first orientation for removing the kingpin.

FIG. 8 depicts a side view of the embodiment of FIG. 6, wherein the truck baseplate is disposed in a second orientation for seating a replacement kingpin.

### DETAILED DESCRIPTION

For the purposes of promoting an understanding of the principles of the invention, reference will now be made to the embodiments illustrated in the drawings, and specific language will be used to describe the same. It should nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. Any other undisclosed or incidental details of the construction or composition of the various elements of the disclosed embodiment of the present invention are not believed to be critical to the achievement of the advantages of the present invention, so long as the elements possess the attributes needed for them to perform as disclosed. The selection of these and other details of construction are believed to be well within the ability of one of even rudimentary skills in this area, in view of the present disclosure. The invention encompasses embodiments both comprising and consisting of the elements described with reference to the illustrative embodiments. Unless otherwise indicated, all ordinary words and terms used herein shall take their customary meaning as defined in The New Shorter Oxford English Dictionary, 1993 edition. All technical terms shall take on their customary meaning as established by the appropriate technical discipline utilized by those normally skilled in that particular art area.

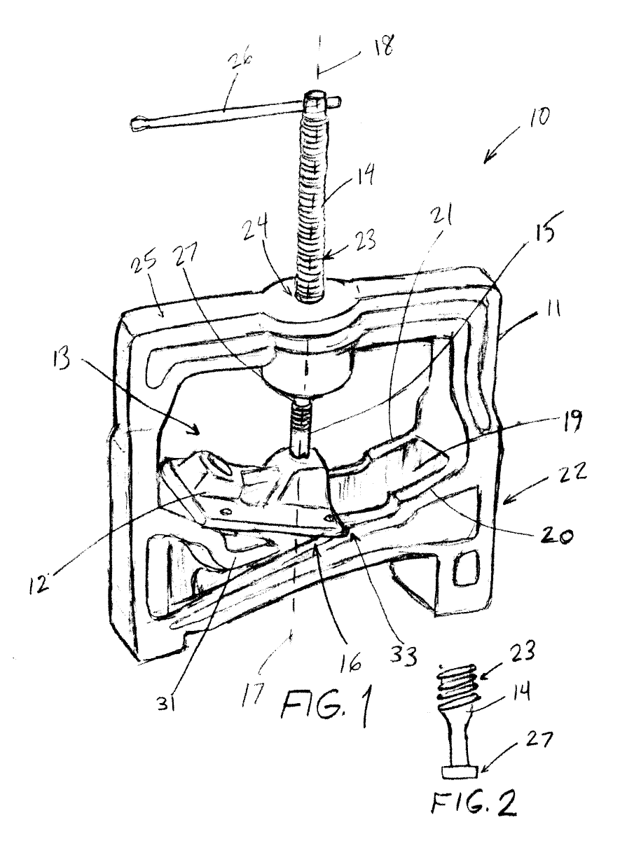

The present invention, as embodied in FIGS. 1-8, comprises a skateboard repair fixture 10 that includes a frame 11, such as one made of cast iron, aluminum, or another material or combination of materials suitable for forming a sturdy fixture capable of holding a workpiece such as the illustrative skateboard truck baseplate 12, a wheel 35, etc., so that the workpiece can be securely maintained therein. The frame is configured to receive and orient the workpiece to facilitate its repair, and an engagement member 14 that are movably coupled to the frame so that it can be advanced to engage the workpiece in a manner that accomplishes a function involved with the repair a defective or worn portion of a skateboard.

In the illustrative example of FIG. 1, the workpiece comprises a particular type or style of a skateboard truck baseplate that is placed in a first orientation 50 within a first support position 13 such that a defective or broken kingpin 15 can be urged from the baseplate to which it is engaged. The first support position comprises a receiving area 16 that includes a pair of notches or similar contour elements along the frame 11. When the truck baseplate 12 is properly positioned in the first support position so that the kingpin 15 is oriented in a vertical position so that the longitudinal axis 17 of the kingpin 15 is aligned with the longitudinal axis 18 of the engagement member 14, the engagement member is rotatably advanced to displace the defective kingpin from the truck baseplate, which then traverses a space 19 located between spaced-apart resting bars 20 and 21 comprising a portion of the base 22 of the frame 11 until the kingpin is dislodged from the baseplate. Although the illustrative example depicts an intact kingpin, the fixture 10 is configured such that the elongate engagement member 14 can contact and urge a sheared or broken kingpin 15 from the truck baseplate in the same manner. In situations where the kingpin is bent, it may be necessary to straighten or shear off the misaligned portion to facilitate removal.

The illustrative engagement member 14 comprises a rod having a threaded portion 23 that is received by a complimentary threaded channel 24 formed within the top portion 25 of the frame so that when the handle 26 is manipulated in a clockwise or counterclockwise motion, the threaded rod is advanced or retracted, depending on the direction of the threads. The distal end 27 of the threaded rod (engagement member 14) comprises a configuration that is adapted to provide sufficient contact to the kingpin 15, such as a broad, flat face, so that the rotational movement of the threaded rod can be transferred thereto. For fixtures intended to repair a single type of kingpin, the distal end 27 can be specially configured to optimize the transfer of rotational movement. In an alternate embodiment, the distal end 27 of the elongate engagement member 14 may be configured to fit over or otherwise engage an end of the kingpin 15 so that the kingpin can be rotated within the truck baseplate 12 to cause movement relative thereto, thereby making the threaded portion 23 of the rod optional since the threaded relationship between the kingpin and truck baseplate can supply the necessary rotational movement. Since the threaded portion of the kingpin typically does not engage threads within the truck baseplate, rotational movement is not necessarily required to generate a force sufficient to dislodge the kingpin. Thus, the engagement member 14 may be alternatively configured to be pushed, hammered, mechanically advanced (e.g., a motor), or otherwise advanced to urge and dislodge the kingpin.

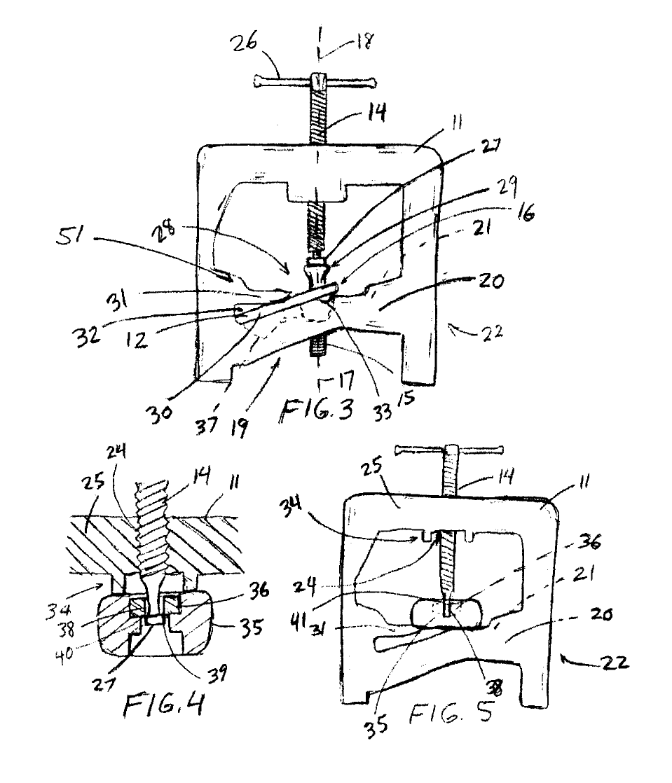

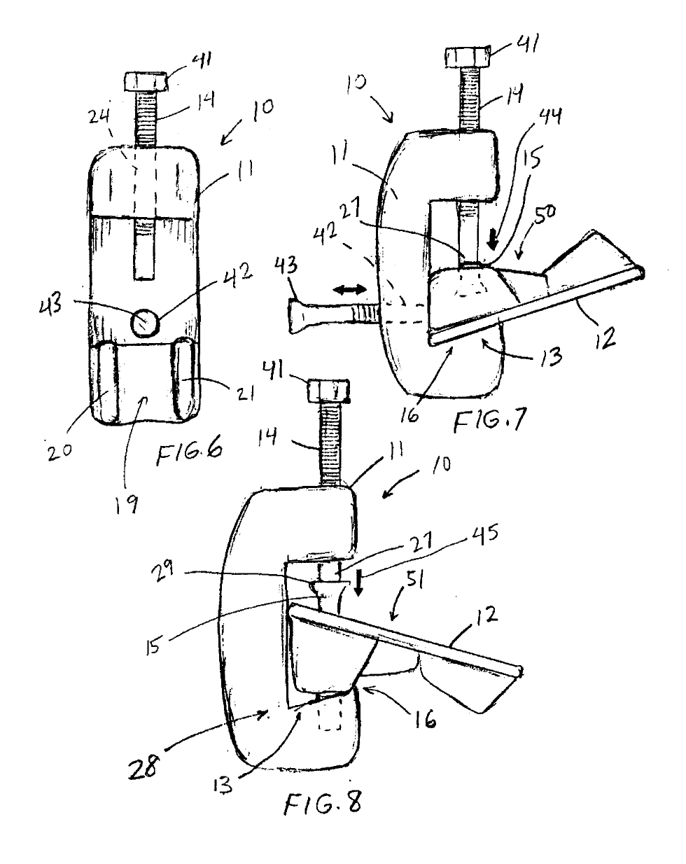

As depicted in FIG. 3, the repair fixture 10 is configured so that not only can the engagement member 14 urge a broken kingpin 15 from a truck baseplate 12 disposed in the first support position 13, the same baseplate can be placed in within a second support position 28 so that the engagement member can align with a replacement kingpin so that it can be inserted and seated within the baseplate. In the illustrative embodiment, the truck baseplate 12 is flipped or inverted from the first orientation 50 for removal to a second orientation 51 in which the head 29 of the kingpin 15 is oriented upward so that it may be contacted by the distal end 27 of the engagement member 14. In the illustrative embodiment, the truck baseplate 12 is oriented into the second support position 28 for inserting the replacement kingpin 15 thereinto by sliding the baseplate underneath a projecting tongue portion 31 that supported the baseplate in the first support position 13 so that baseplate now resides in a slot 32 created thereunder. The base 30 of the truck baseplate 12 (which attaches to the board) rests on spaced-apart resting bars 20,21 of the frame base portion 22 with the remainder of the baseplate (lower portion 37) being disposed in the space 19 therebetween. With the kingpin longitudinal axis 17 aligned with the axis 18 of the threaded rod, the rod may be rotatably advanced toward the head 29 of the replacement kingpin until it is contacted and urged into place within the truck baseplate. The frame should be dimensioned such that there is sufficient space between the top portion 25 and the base portion 22 of the frame so that the truck baseplate can be oriented to either the first orientation 50 (FIG. 1) or the second orientation 51 (FIG. 3) with the kingpin 15 fully extended, thereby allowing the elongate engagement member 14 to perform either the insertion of removal function. The illustrative frame measures approximately 6.75″ wide and 6.5″ high overall. The illustrative truck baseplate (Independent Truck Co., Santa Cruz, Calif.) extends vertically approximately 2.3″ from the paired receiving notches 33 when oriented in the first position 13, although other styles or brands of truck baseplates may require more or less space.

The illustrative skateboard repair fixture 10 may be advantageously configured with multiple receiving areas 16 so that more than one style or brand of truck baseplate may be positioned therein to remove or replace the kingpin. As depicted in FIGS. 1-2, the resting bars 20,21 include a series of angles, contours, and receiving notches that can be configured to create a receiving area 16 to orient a particular type of truck baseplate in a first or second orientation so that the kingpin is generally aligned with the engagement member 14 for removal or insertion of thereof. For example, the truck baseplate 12 of FIG. 1 is shown oriented in its predetermined receiving area 16 (first support position 13), while the fixture 10 is also configured such that a second truck baseplate 12 manufactured by Thunder may be oriented in a second receiving area, rotated 180° with respect to the depicted skateboard baseplate (Independent) so that one edge of the truck baseplate rests against the leading edge of the tongue portion 31. Optionally, the frame 11 may include indicia (not shown) or accompanying diagrams to indicate the appropriate receiving area 16 or orientation for a particular brand or style of truck baseplate (e.g., a particular notch or shelf position used of orientation, etc.). With the wide variety of truck baseplate styles available from several different manufacturer, it may not be practical to design a plurality of support positions resulting in a true universal fixture; however, a fixture may easily be configured to accept multiple types of baseplates for kingpin insertion or removal by utilizing of the different contoured surfaces or receiving points to seat a particular baseplate in the desired orientation. It may be such that two or more baseplate styles may be positionable within the same receiving area 16 or support position due to shared structural similarities along at least one aspect. For example, the truck baseplates manufactured by Independent and Truck generally share a common second support position 28 (with the second orientation 51), as depicted in FIG. 3. It is within the scope of the invention to have differently configured detachable receiving areas 16 that may be coupled to the base of the frame, thereby accommodating the need to extract and install kingpins from different styles and brands of skateboard truck baseplates with providing for a ‘universal’ fixture.

FIGS. 6-8 depicts an embodiment of the present invention in which the fixture is sized and configured to be hand held during the operation to remove the kingpin 15 from the truck baseplate 12 and install its replacement. Like the embodiment of FIG. 1, the engagement member 14 comprises a threaded rod in which the threaded portion 23 is received within a threaded channel 24 traversing the frame 11, although an unthreaded relationship therebetween is possible, as discussed above. A first support position 13 of the frame comprises space-apart resting elements 20,21 for receiving the truck baseplate 12 thereagainst in the first orientation 50. The space 19 between the resting elements permits passage of the kingpin 15 and distal end 27 of the engagement member as they are advanced in the first direction 44 (relative the baseplate) during removal. The engagement member 14 is extendable by rotation of the head portion 41 to contact the kingpin 15 (shown sheared off at the baseplate 12 in FIG. 7) when the baseplate lies in the first orientation 50. Rather than being configured to have a first support position 13 to position the truck baseplate 12 in the first orientation 50 for kingpin removal and a different second position for positioning the baseplate in the second orientation 51 for seating the replacement kingpin (FIG. 8), the frame is configured such that first support position may receive the truck baseplate in either the first or second orientation 50,51, thereby allowing for either operation. The truck baseplate 12 is merely flipped or inverted to rest against the frame such that the distal end 27 of the engagement member 14 contacts the head 29 of the replacement kingpin 15 and further advancement of the engagement member in the second direction 45 relative the baseplate seats the kingpin into the truck baseplate. Thus, in the illustrative fixture 10, a single receiving area 16 comprises both the first and second support positions that provide for the first and second orientations.

Still referring the embodiment of FIGS. 6-8, the engagement member 14 lacks a handle 26 like that shown in the previous embodiment of FIG. 1 in order that the illustrative fixture 10 may be made compact enough to conveniently carried by the user, such as within a pocket. Rather than include an integral means to facilitate rotation of the engagement member, the head 41 thereof comprises a common-size hexagonal head so that the integral hexagonal wrench of a typical skateboard tool, such as that commonly carried by skateboard users (not depicted), can be attached thereto for providing torque to rotate and advance (or reverse) the threaded rod. Alternatively, a detachable handle portion could be provided with the fixture 10, such as one that is storable within the frame 11 (e.g., within a chamber or recess therein) or the engagement member head 41 could comprise a wing nut head or other configuration to facilitate manual rotation. Like the embodiment of FIG. 1, the engagement member can be configured to be advanced to contact the kingpin by striking the head against a hard surface, a tool, or otherwise applying force to the head.

While the illustrative embodiment of FIGS. 6-8 is configured such that a particular skateboard truck baseplate can assume both the first and second orientations while in the same first support position 13, other styles of truck baseplates may not be configured so that they can be properly oriented and aligned with the engagement member 14 in the first support position provided. This can be addressed by having dedicated fixtures for each type of truck baseplate. Alternatively, an adjustment member 43 may be coupled to the frame 11 and configured to be extendable and retractable such that it may contact and adjust the position or orientation of a second (or third) style of a truck baseplate within the first support position 13. The illustrative adjustment member 14 comprises a kingpin 15 or threaded member that is received within a second threaded channel 42 traversing the frame. When a particular style of a truck baseplate is not compatible with the first support position, the adjustment member 43 is rotated and advanced until it contacts the truck baseplate 12 residing in the first support position. The adjustment member 14 is then manipulated either forward or backward, causing adjustments to the orientation of the baseplate 12 until the particular style of a baseplate is in the first or second orientation within the support position and the engagement member and kingpins are brought into alignment such that the kingpin can be extracted or a replacement installed. While each of the illustrative embodiments depicts a single engagement member, it is within the scope of the invention to have a first engagement member at one end of the frame for dislodging the defective kingpin from the truck baseplate in the first orientation while having a second engagement member located at the opposite end of the frame to provide the means for seating the replacement kingpin in the truck baseplate. In such an embodiment, both the first and second support positions, as well as the first and second orientations of the baseplate, would remain the same such that the baseplate would not have to be respositioned.

In addition to facilitating the repair of a truck baseplate, the repair fixture 10 of the present invention may be further configured to assist in the repair of other components of the skateboard, such as to aid in the removal or insertion of a skateboard wheel bearings. FIG. 4 depicts a repair fixture 10 comprising a frame top portion 25 that includes spacing structure 34 comprising two projections oppositely situated one either side of the threaded channel 24 through which the elongate engagement member extends. The spacing structure 34 extends downward from the frame 11 to provide a surface against which a detached skateboard wheel 35 can be situated so that the engagement structure 14 can be advanced downward to contact and remove a worn wheel bearing 36 that is seated within the wheel portion, as shown. The distal end 27 of the engagement member is configured so that it can traverse the center channel 38 of the bearing as depicted in FIG. 4. When the wheel 35 is then moved laterally, the distal end 27, when configured to include a lip 39 therealong, is able to ‘hook’ behind the bearing along a shelf 40 or inner lip adjacent the central channel 38. While manually maintaining the wheel in that position, the direction of the engagement member 14 is then reversed so that as the wheel is held securely against the spacing structure 34 and the bearing 36, which is frictionally seated within the wheel, is urged therefrom. The spacing structure 34 is configured and dimensioned such that sufficient space is left above the wheel 35 to pull the bearing 36 completely or sufficiently therefrom for removal. Because skateboard wheels can be different thicknesses and diameters, the spacing structure preferably is configured to adapt to range of wheel sizes. If this is not a concern, the spacing structure can be optionally configured to receive a particular type and size of wheel, providing a shelf structure beneath (not illustrated) to help maintain the wheel against the frame such that it need not be manually held there during bearing extraction. As an alternative to configuring the top portion for extracting the bearing 36 with the distal end 27 of the engagement member 14, another portion of the fixture can be adapted to fulfill the same function, e.g., the end of the threaded rod handle 26 can be shaped such that it may be used to pry the bearing 36 from its seat within the wheel 36.

To seat a replacement bearing 36 in the wheel 35, the wheel is positioned so that it rests on the resting bars 20,21 on one side and the tongue portion 31 on the other so that it is relatively level and generally centered beneath the elongate engagement member 14 (FIG. 5). The elongate engagement member 14 through the central channel 38 of the bearing 36 until the shoulder 41 of the elongate engagement member contacts a lip on the upward face of the bearing so that further advancement of the engagement member 14 forces the bearing 36 it into the wheel 35 until it is fully seated therein.

It is therefore intended that the foregoing detailed description be regarded as illustrative rather than limiting, and that it be understood that it is the following claims, including all equivalents, that are intended to define the spirit and scope of this invention.

What is claimed is:

1. A fixture for repairing a skateboard, comprising:
a frame configured for receiving and orienting a skateboard truck baseplate within in a predetermined first support position within the frame;
an engagement member movably coupled to the frame such that the engagement member is extendable to contact a kingpin or a portion thereof disposed in the truck baseplate then the truck baseplate is placed in a first orientation within the first support position within the frame with the longitudinal axis of the elongate engagement member being generally aligned with the longitudinal axis of the kingpin such that the engagement member is further extendable to urge and dislodge the kingpin or a portion from the truck baseplate; and
and wherein the frame is further configured to receive the skateboard truck baseplate in a second orientation within a predetermined second support position about the frame in which the longitudinal axis of the engagement member is generally aligned with the longitudinal axis of the kingpin such that the replacement kingpin may be seated into the truck baseplate by advancement of the engagement member thereagainst.

2. The fixture of claim 1, wherein the frame further includes a plurality of receiving positions located thereabout that are configured for the insertion of and the removal of the kingpins from a plurality of different configurations of the truck baseplate.

3. The fixture of claim 1, wherein the engagement member comprises a threaded rod received in a threaded channel within the fixture.

4. The fixture of claim 1, wherein the frame in configured to receive a skateboard wheel therealong such that the engagement member may be aligned therewith and inserted thereinto to engage the bearing of the wheel to remove it therefrom by the rotating action of the elongate engagement member.

5. The fixture of claim 1, wherein the frame is configured to receive a skateboard wheel therealong such that engagement member may be aligned therewith to facilitate contact the center portion of the wheel to seat a replacement bearing thereinto.

6. The fixture of claim 1, wherein the first support position and the second support position generally comprise a common receiving area of the frame.

7. The fixture of claim 1, wherein the frame comprises a base configured to rest upon a surface during a repair procedure.

8. A fixture for repairing a skateboard, comprising:
a frame configured to receive a first skateboard truck baseplate into a first support position therein such that the skateboard truck baseplate assumes a first orientation for removal of a defective kingpin therefrom;
an engagement member operably connected to the frame such that it is extendable to contact the defective kingpin of the skateboard truck baseplate, the longitudinal axis of the engagement member being generally aligned with the longitudinal axis of the kingpin when the first skateboard truck baseplate is disposed in the first orientation within the first support position such that further advancement of the engagement member causes the kingpin to be urged in first direction relative to the skateboard truck baseplate until it is disengaged therefrom; and
wherein the frame is configured to receive the first skateboard truck baseplate in a second orientation therein in which the kingpin is generally aligned with the engagement member such that the advancement of the engagement member urges the replacement kingpin in a second direction relative to the first skateboard truck baseplate until it is seated therein.

9. The fixture of claim 8, wherein the elongate engagement member comprises a threaded rod.

10. The fixture of claim 8, wherein the frame in configured to receive a skateboard wheel therealong such that the elongate engagement member may be aligned therewith and inserted thereinto to engage the bearing of the wheel to remove it therefrom by the rotating action of the elongate engagement member.

11. The fixture of claim 8, wherein the frame is configured to receive a skateboard wheel therealong such that elongate engagement member may be aligned therewith to facilitate contact the center portion of the wheel to seat a replacement bearing thereinto.

12. The fixture of claim 8, wherein the fixture further comprises an adjustment member configured to allow differently configured skateboard truck baseplates to be oriented within the first support position such that the engagement member is in alignment with the broken/replacement kingpin thereof to be urged in the first and/or second direction.

13. The fixture of claim 12, wherein the adjustable member is configured such that the skateboard truck can be reoriented while disposed in the first or the second position such that the engagement member is in alignment with the kingpin located with the skateboard truck.

14. The fixture of claim 12, wherein the adjustable member comprises the replacement kingpin.

15. The fixture of claim 8, wherein the frame is configured to fit within the palm of an operator's hand during a repair procedure.

16. The fixture of claim 8, wherein the first support position and the second support position generally comprise a common receiving area of the frame.

17. The fixture of claim 8, wherein the engagement member comprises a first engagement member and a second engagement member located oppositely thereof along the frame such that the first engagement member is configured to dislodge the kingpin from the truck baseplate and the second engagement member is configured to seat a replacement kingpin into the truck baseplate.
